(19) United States
(12) Patent Application Publication
(10) Pub. No.: US 2011/0196716 A1
(43) Pub. Date: Aug. 11, 2011

(54) LEAD QUALIFICATION BASED ON CONTACT RELATIONSHIPS AND CUSTOMER EXPERIENCE

(75) Inventors: Niranjan Srinivasan, Bellevue, WA (US); Christopher S. Hargarten, Seattle, WA (US); Ashvin J. Mathew, Kirkland, WA (US); Preethi Ramarathinam, Redmond, WA (US)

(73) Assignee: Microsoft Corporation, Redmond, WA (US)

(21) Appl. No.: 12/703,736

(22) Filed: Feb. 10, 2010

(51) Int. Cl. G06Q 10/00

(52) U.S. Cl. 705/7.29

(57) ABSTRACT

A lead qualification system receives from a potential customer lead information that includes an identification of the potential customer. The lead qualification system then identifies attributes of the potential customer. To qualify a lead, the lead qualification system may generate a lead score based on an experience score and a contact score. To generate the experience score, the lead qualification system may analyze sales history and other information of customers that have attributes similar to the potential customer. To generate the contact score, the lead qualification system may analyze the business relationships between people of the sales organization and the potential customer. The lead qualification system may generate the lead score by combining the contact score and the experience score.

### BACKGROUND

Enterprise Resource Planning (“ERP”) software is a type of software used by many organizations to plan and manage various business functions, such as budgeting, accounting, human resources, inventory, customer relationships, sales, and so on. ERP software typically provides access to a database from which users and applications may retrieve information related to the various business functions. The database may contain a wealth of information about the organization and its customers. For example, the database may include a customer table that contains a comprehensive list of all the customers along with detailed information about each customer. The detailed information may include contact information, customer addresses, customer industry codes, names of principals of the customers, and so on. As another example, the database may include a sales history table that provides a record for each sale made to a customer along with sales details such as product identifier, quantity, price, sale date, and so on.

A sales organization, such as a company selling a product, can increase its sales by making additional sales to its current customers or by expanding its customer base to new customers. Traditionally, sales organizations identify potential customers, also referred to as “leads,” in various ways. For example, a sales organization may sponsor a booth at a trade show and develop leads based on discussions with attendees or business cards provided by attendees. As another example, a sales organization can develop leads using advertisements that describe their products and provide telephone numbers that a potential customer can call to obtain additional information. The World Wide Web has provided additional opportunities for sales organizations to expand their customer base. A sales organization may provide a web site through which potential customers can access information on products being offered for sale. The web site may provide very detailed information about the products including product specifications, video tutorials, product testimonials by customers, and so on. Such a sales web site typically provides an information request web page through which a potential customer can register to receive additional information about the products. The information request web page may prompt the user to provide their name, title, company they represent, electronic mail address, telephone number, and so on and may allow the user to request additional product information, ask to talk to a salesperson, and so on.

Many sales organizations have struggled to determine which leads are likely to be beneficial (e.g., result in sales significant enough to justify the sales effort) and which leads are not likely to be beneficial. A large sales organization may receive hundreds of leads a day with only a small percentage being likely to be beneficial. Although the sales organization could follow up on every lead, it would be more efficient if the sales organization would follow up on only those leads that are likely to be beneficial. To help identify which leads are beneficial, sales organizations typically attempt to “qualify” the leads. For example, if a potential customer visits an information request web page and submits an information request with the name of the person listed as Mickey. Mouse or with a contact telephone number of 111-111-1111, then that lead is not likely to be beneficial. The process of qualifying a lead may have some automatic aspects and some manual aspects. For example, a lead may be automatically disqualified if the telephone number is not valid or if the company name cannot be found in a directory of companies. A salesperson may also manually disqualify a lead when the lead contains information that appears to be inconsistent, such as an individual with no corporate affiliation requesting information on a multimillion-dollar product.

Although current techniques for automatically qualifying leads help to disqualify leads that are obviously not likely to be beneficial, there are many leads that are qualified that turn out to be not beneficial. As the number of leads increases, especially as a result of advertisements via the web, the amount of resources expended on following up on qualified leads that turn out to be not beneficial has increased dramatically. Similarly, not following up on leads that are incorrectly disqualified can result in significant lost opportunities. As a result, the effectiveness of sales organizations has been less than desired.

### SUMMARY

A method and system for qualifying business leads based on contact relationships and customer experience is provided. A lead qualification system receives from a potential customer lead information that includes an identification of the potential customer. The lead qualification system then identifies attributes of the potential customer. To qualify a lead, the lead qualification system may generate a lead score for the lead. The lead qualification system may consider leads with lead scores above a qualified lead threshold to be qualified. To generate the lead score, the lead qualification system may analyze sales history and other information of customers that have attributes similar to the potential customer to generate an experience score. If customers with similar attributes tend to be highly profitable, then the lead qualification system increases the lead score. The lead qualification system may also access a business network store describing business relationships between people associated with various organizations to generate a contact score. The lead qualification system may increase the lead score when the business relationships between people of the sales organization and the potential customer appear to be strong relationships. The lead qualification system may also analyze the interactions of a session in which a potential customer entered the lead information to generate a behavioral score. The lead qualification system may increase the lead score when a potential customer spends a considerable amount of time browsing the web pages of the business. The lead qualification system may generate the lead score by combining various constituent scores such as a contact score, an experience score, and a behavioral score.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a display page for collecting lead information from a potential customer in some embodiments.

FIG. 2 is a block diagram that illustrates components of a lead qualification system in some embodiments.

FIG. 3 is a block diagram illustrating a logical organization of the information in a lead table in some embodiments.

FIG. 4 is a block diagram that illustrates a logical organization of the customer table of the ERP database in some embodiments.

FIG. 5 illustrates a display page for setting weights for constituent scores in some embodiments.

FIG. 6 illustrates a display page for setting weights for the ratings of rating companies for generating a rating score in some embodiments.

FIG. 7 is a flow diagram that illustrates the processing of the score lead component of the lead qualification system in some embodiments.

FIG. 8 is a flow diagram that illustrates the processing of the generate experience score component of the lead qualification system in some embodiments.

FIG. 9 is a flow diagram that illustrates the processing of the generate rating score component of the lead qualification system in some embodiments.

FIG. 10 is a flow diagram that illustrates the processing of the generate contact score component of the lead qualification system in some embodiments.

FIG. 11 is a flow diagram that illustrates the processing of the generate combined score component of the lead qualification system in some embodiments.

FIG. 12 is a flow diagram that illustrates the processing of the train lead experience classifier component of the lead qualification system in some embodiments.

### DETAILED DESCRIPTION

A method and system for qualifying business leads based on contact relationships and customer experience is provided. In some embodiments, a lead qualification system receives from a potential customer lead information that includes an identification of the potential customer. For example, the potential customer (actually typically a representative of the potential customer) may provide the information via a web page through which product information can be requested from a sales organization. The lead qualification system then identifies attributes of the potential customer. For example, the attributes may be identified from the lead information itself, such as industry type or anticipated purchase quantity included with the lead information. As another example, the attributes may be identified from various other data sources such as a company report provided by a third-party reporting service. To qualify a lead, the lead qualification system may generate a lead score (e.g., between 0 and 1.0) for the lead. The lead qualification system may consider leads with lead scores above a qualified lead threshold to be qualified. To generate the lead score, the lead qualification system may analyze sales history and other information of customers that have attributes similar to the potential customer. For example, the lead qualification system may determine similarity based on industry type, number of employees, geographic location, and so on. If customers with similar attributes tend to be highly profitable, then the lead qualification system increases the lead score. The lead qualification system may also access a business network store describing business relationships between people associated with various organizations. The lead qualification system may increase the lead score when the business relationships between people of the sales organization and the potential customer appear to be strong relationships. For example, a sales manager may have a business relationship with a procurement manager of the potential customer. The business relationships may be derived from an electronic mail contact list of the sales manager. The lead qualification system may generate the lead score by combining various constituent scores such as a contact score and an experience score. In this way, the lead qualification system qualifies leads based on a combination of the strength of business contacts with the potential customer and past experience with customers having similar attributes as the potential customer.

In some embodiments, the lead qualification system may also factor into the lead score “analytics” derived from the potential customer's interaction during the session in which the representative interacts with the information request web page. During the session, the representative may provide the information requested by the information request web page and may browse to additional information about the sales organization and its products. For example, the representative may view various tutorials about the products and may view customer testimonials. The lead qualification system tracks and logs the actions performed by potential customers. For example, the lead qualification system may log each button selected and each web page visited along with the time of the action. The actions relating directly to providing the requested information during the session are referred to as primary actions and the other actions are referred to as secondary actions. The analytics developed by the qualification system may include time spent viewing each web page, whether a video of a product was viewed its entirety, whether an audio customer testimonial was played, and so on. Based on the analysis of the analytics, the lead qualification system may increase or decrease the lead score. For example, if a representative visited several web pages and viewed the corresponding tutorials, then the lead qualification system may increase the lead score. In contrast, if a representative only accesses the information request web page and no other web page, then the lead qualification system may decrease the lead score. As another example, the lead qualification system may increase the lead score for returning customers that may take into consideration frequency and durations of visits. The lead qualification system may also decrease a lead score as the time since the lead was submitted increases.

In some embodiments, the lead qualification system may also factor into the lead score rating information about the potential customer. For example, the rating information may be provided by a third-party organization (e.g., Dun & Bradstreet or Moody's). The lead qualification system may increase the lead score for potential customers with high ratings and decrease the lead score for potential customers with low ratings.

In some embodiments, the lead qualification system may generate an analytics score based on the analytics, an experience score based on sales experience with customers having similar attributes, a contact score based on business relationships between the sales organization and that potential customer, and a ratings score based on ratings of the potential customer. The lead qualification system may then aggregate some or all of these constituent scores into the lead score. The lead qualification system may use a weighted aggregation that may be specified by the sales organization. For example, the sales organization may specify to weight the analytics score, experience score, contact score, and rating score as 20%, 30%, 40%, and 20%, respectively. If each of the constituent scores ranges between 0 and 1.0, then scores 0.5, 0.7, 0.5, and 0.2 for the analytics score, experience score, contact score, and rating score, respectively, would result in a lead score of 0.50 (i.e., 0.5*0.1+0.7*0.3+0.5*0.4+0.2*0.2), whereas scores of 0.4, 0.8, 0.7, and 0.1 would result in a lead score of 0.58 (i.e., 0.4*0.1+0.8*0.3+0.7*0.4+0.1*0.2). The lead qualification system may also apply a non-linear weighting to the constituent scores of other scores described below.

In some embodiments, the lead qualification system may designate a lead as qualified when its lead score exceeds a qualified lead threshold. The lead qualification system may allow a sales organization to specify the qualified lead threshold. Alternatively, the lead qualification system may learn the qualified lead threshold based on analysis of leads that turn out to be beneficial and those that turn out not to be beneficial. The lead qualification system may apply various statistical analysis techniques such as linear regression to learn the qualified lead threshold. Similarly, the lead qualification system may derive the lead score from the analytics score, experience score, contact score, and rating score based on analysis of leads that turn out to be beneficial and not beneficial. For example, the lead qualification system may apply a machine learning algorithm, such as a neural network, to learn the appropriate weights for the different scores.

In some embodiments, the lead qualification system may train a lead experience classifier to classify leads based on the qualification. The classification may result in a continuous lead score between 0 and 1.0 or in discrete categories such as highly qualified, qualified, marginally qualified, and not qualified. To train the lead experience classifier, the lead qualification system may input training data that includes, for each customer of the sales organization, attributes of that customer along with an experience score, which may range between 0 and 1.0 with 1.0 indicating the most favorable experience. For example, the customer who has been most profitable for the sales organization may be given an experience score of 1.0, and a customer with only one small sale may be given an experience score of 0.05. The experience score may be manually provided by a salesperson or may be derived automatically based on analysis of the sales history of that customer. The lead qualification system then trains the lead experience classifier to classify potential customers based on their attributes. Various well-known training techniques may be used such as a support vector machine, decision tree, neural network, regression analysis, and so on. Once the lead experience classifier is trained, the lead qualification system classifies a potential customer by identifying its attributes and applying the lead experience classifier to those attributes to generate the experience score for that potential customer.

In some embodiments, the lead qualification system may generate an experience score derived from the similarity between a potential customer and other customers based on a distance in a multidimensional vector space of customer attributes. The lead qualification system may initially cluster the customers of the sales organization using a clustering technique such as a k-nearest neighbor algorithm. Each cluster may be assigned a centroid feature vector representing the cluster and a cluster experience score. To generate an experience score for the potential customer, the lead qualification system identifies the cluster with the minimum distance between the feature vector of the potential customer and the centroid feature vector and uses the cluster experience score of that cluster as the experience score for the potential customer.

In some embodiments, the lead qualification system may access a business network store containing a network representation of people and their business relationships. The business network may contain a node representing each person with links between nodes representing direct business relationships between people. For example, a link between the nodes representing a president and a vice president of an organization indicates that they have a direct business relationship. The business network may also annotate the links with an indication of the strength of the relationship between the people represented by the nodes. For example, the strength of the relationship between the president and the vice president of the same organization may be high, whereas the strength of the relationship between the president and an employee in the mailroom may be low. In addition, the people represented in the business network may span multiple organizations. For example, the business network may include a node for each employee of an organization and a node for each person listed in a contact list of an employee of the organization. The strengths of the relationships may be calculated based on analysis of attributes associated with related people. For example, the attributes may include level within a hierarchy of an organization, the title of the person within an organization, number of communications (e.g., phone calls and electronic mail messages) between the people in the last year, and so on. In addition, the business network may represent the strength of indirect relationships between people who have no direct relationship. For example, if five vice presidents of one organization have strong direct relationships with five vice presidents of another organization, but the presidents of the organizations have no direct relationship, then the presidents may be considered to have a strong indirect relationship. The generation of such a business network and the calculation of the strengths of relationships are described in U.S. patent application Ser. No. ______ (Attorney Docket No. 41826.8523) entitled “IDENTIFYING INTERMEDIARIES AND POTENTIAL CONTACTS BETWEEN ORGANIZATIONS,” which is being filed concurrently and is hereby incorporated by reference.

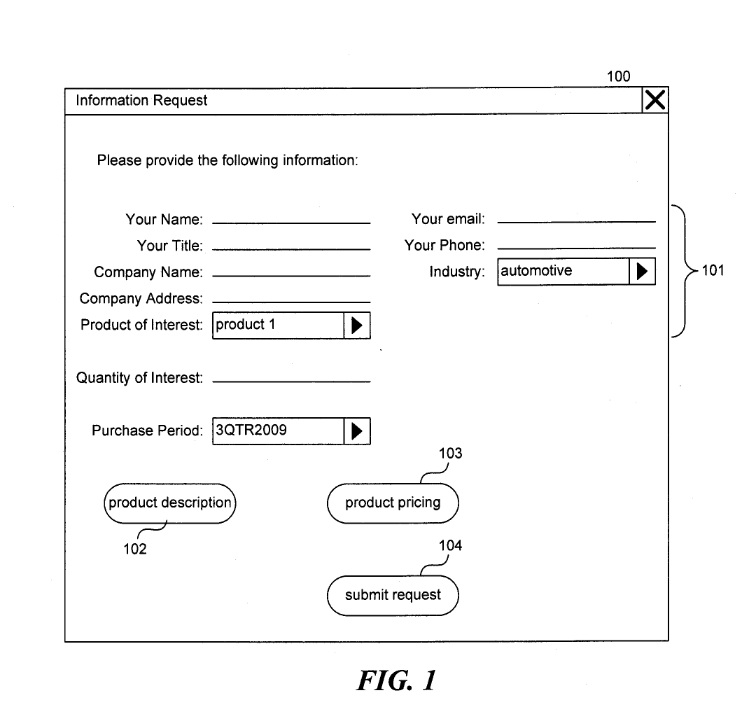

FIG. 1 illustrates a display page for collecting lead information from a potential customer in some embodiments. The display page 100 may include a data entry area 101, a product description button 102, a product pricing button 103, and a submit request button 104. The data entry area includes various fields for entering information about the potential customer such as name, title, and so on and about a product of interest such as product identifier, quantity desired to be purchased, and so on. The representative of the potential customer selects the product description button to visit web pages providing detailed information about products offered by the sales organization. The representative selects the product pricing button to visit web pages providing product pricing information. The representative selects the submit request button to submit the information request with the lead information collected from the data entry area. The primary actions are considered to be the actions of entering the data in the data entry area, and the secondary actions are considered to be the actions associated with viewing the product description and product pricing web pages.

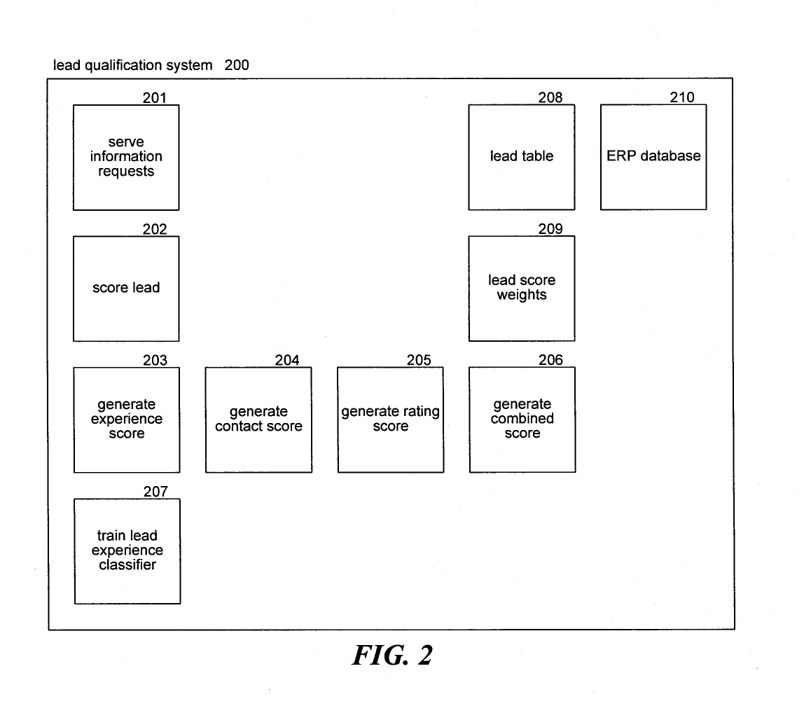

FIG. 2 is a block diagram that illustrates components of a lead qualification system in some embodiments. The lead qualification system 200 may include a serve information requests component 201, a score lead component 202, a generate experience score component 203, a generate contact score component 204, a generate rating score component 205, a generate combined score component 206, and a train lead experience classifier component 207. The lead qualification system may also include a lead table 208, a lead score weights store 209, and an ERP database 210. The serve information requests component serves information request web pages, such as the one illustrated in FIG. 1, to collect lead information from potential customers. The serve information requests component stores the collected lead information in the lead table. The score lead component generates scores for leads by invoking the generate experience score component, the generate contact score component, the generate rating score component, and the generate combined score component to generate the constituent scores and the combined score. The constituent scores may be combined using the weights of the lead score weights store. The lead qualification system invokes the train lead experience classifier component to input the training data and to train the lead experience classifier.

The computing device on which the lead qualification system may be implemented may include a central processing unit, memory, input devices (e.g., keyboard and pointing devices), output devices (e.g., display devices), and storage devices (e.g., disk drives). The memory and storage devices are computer-readable storage media that may contain instructions that implement the lead qualification system. In addition, the data structures and message structures may be transmitted via a data transmission medium, such as a signal on a communications link. Various communications links may be used, such as the Internet, a local area network, a wide area network, or a point-to-point dial-up connection.

The lead qualification system may be implemented in and/or used by various operating environments. The operating environment described herein is only one example of a suitable operating environment and is not intended to suggest any limitation as to the scope of use or functionality of the lead qualification system. Other well-known computing systems, environments, and configurations that may be suitable for use include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The lead qualification system may be described in the general context of computer-executable instructions, such as program modules, stored in a storage device and executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

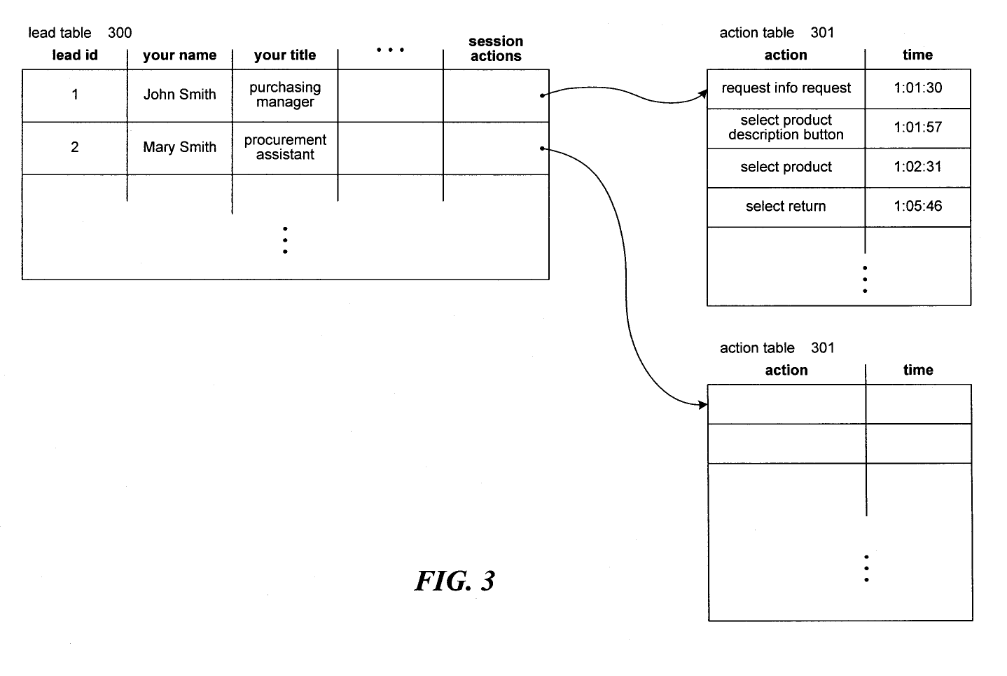

FIG. 3 is a block diagram illustrating a logical organization of the information in a lead table in some embodiments. The lead table 300 includes an entry for each collected lead. Each entry includes a lead identifier and a field for each type of collected lead information. Each entry may include a reference to an action table 301. An action table contains a log of the representative's secondary actions during the session in which the lead information was collected. Each entry of the action table specifies an action along with the time of the action. For example, an action may be to select the product description button 102 of FIG. 1. The lead qualification system can determine from the action table the length of time that a representative spent visiting each web page. More time spent on viewing web pages may indicate a more interested potential customer whose lead score should be increased.

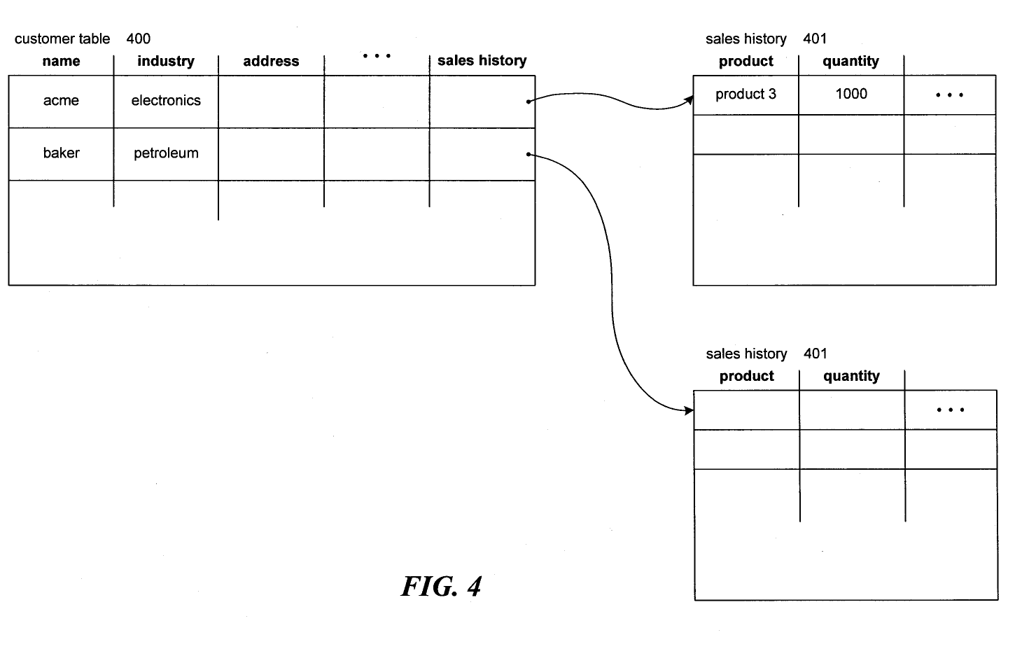

FIG. 4 is a block diagram that illustrates a logical organization of the customer table of the ERP database in some embodiments. The customer table 400 may include an entry for each customer of the sales organization. Each entry contains fields for various attributes of the customer such as customer name, customer industry, customer address, and so on. Each entry may also include a reference to a sales history table 401. The sales history table for a customer contains an entry for each sale to that customer. Each entry may identify the product that was sold, the quantity sold, the price, the date of the sale, and so on. Each entry may also include a lead identifier if the sale was initiated based on a lead. The lead qualification system may use the lead identifier to help identify types of leads that led to sales for use in qualifying future leads.

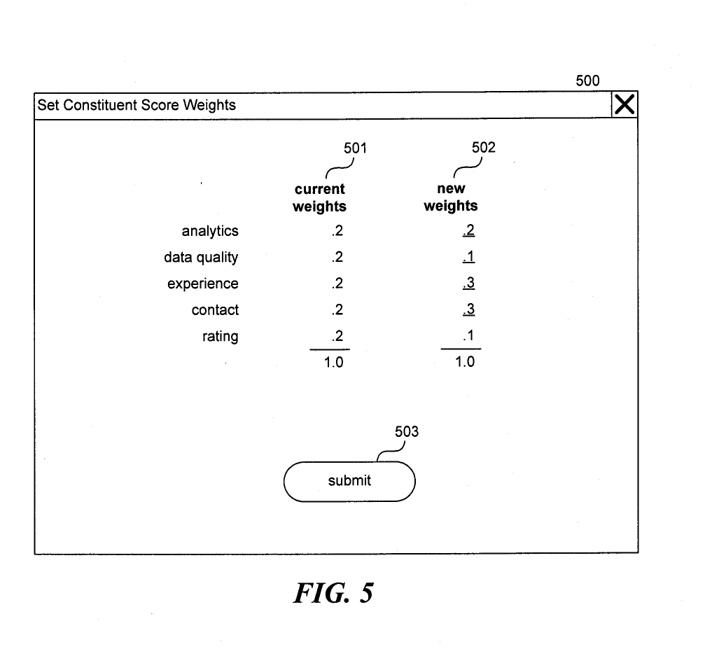

FIG. 5 illustrates a display page for setting weights for constituent scores in some embodiments. The display page 500 includes current weights fields 501, new weights fields 502, and a submit button 503. A salesperson can view the current weights and enter new weights and then select the submit button to submit the new weights. As illustrated by this display page, a salesperson may specify weights for an analytics score, a data quality score, an experience score, a contact score, and a rating score. A data quality score refers to a scoring of the quality of the information that may include whether an electronic mail address is provided or whether a telephone number is valid.

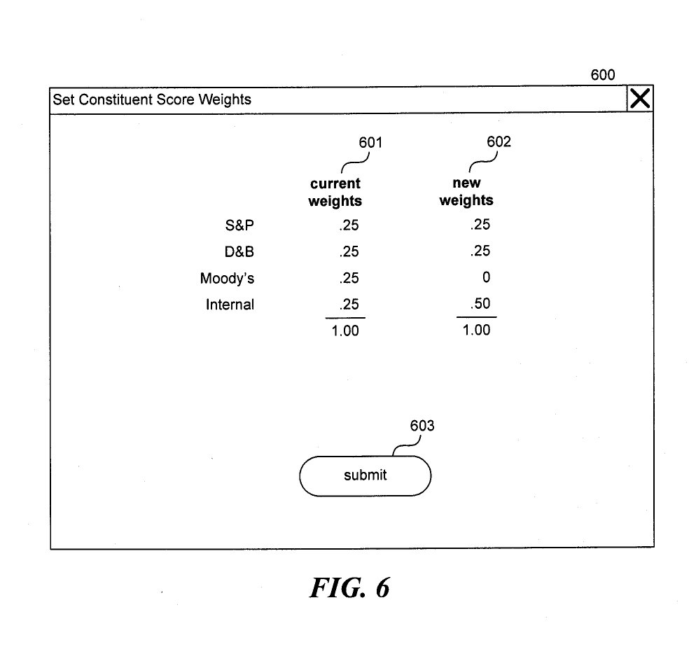

FIG. 6 illustrates a display page for setting weights for the ratings of rating companies for generating a rating score in some embodiments. The display page 600 includes current weights fields 601, new weights fields 602, and a submit button 603. The salesperson can view the current weights and enter new weights and then select the submit button to submit the new weights. These weights are used when generating a rating score. For example, the new weight for the S&P rating is 0.25, meaning that it accounts for 25% of the rating score, and the new weight for the Moody's rating is 0, meaning that it is not factored into the rating score. The internal rating may correspond to a rating developed internally by the sales organization. Each of the other constituent scores may similarly have user-specified weights. For example, an analytics score may be derived from the time spent on viewing certain web pages and time spent viewing certain tutorials. A salesperson may specify a weight for each web page and each tutorial.

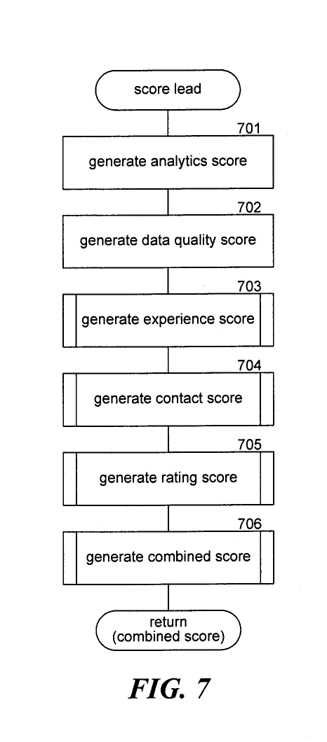

FIG. 7 is a flow diagram that illustrates the processing of the score lead component of the lead qualification system in some embodiments. The score lead component is passed an identifier of a lead in the lead table and returns a lead score. In block 701, the component generates an analytics score. In block 702, the component generates a data quality score. In block 703, the component invokes the generate experience score component to generate an experience score. In block 704, the component invokes the generate contact score component to generate a contact score. In block 705, the component invokes the generate rating score component to generate a rating score. In block 706, the component invokes the generate combined score component to generate a combined score from the analytics score, the data quality score, the experience score, the contact score, and the rating score. The component then returns the combined score as the lead score.

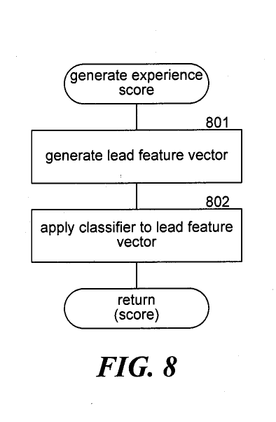

FIG. 8 is a flow diagram that illustrates the processing of the generate experience score component of the lead qualification system in some embodiments. The component is passed a lead identifier and returns an experience score for that lead. In block 801, the component generates a lead feature vector based on the attributes of the lead as stored in the lead table. In block 802, the component applies the lead experience classifier to the lead feature vector to generate the experience score. The component then returns the experience score.

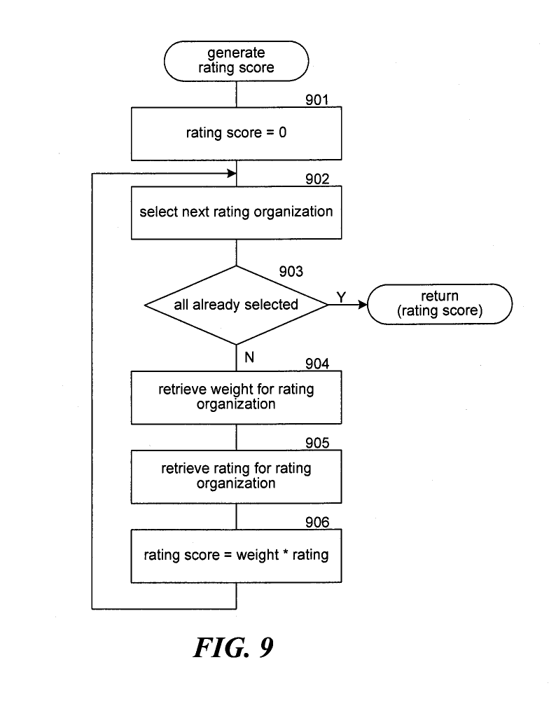

FIG. 9 is a flow diagram that illustrates the processing of the generate rating score component of the lead qualification system in some embodiments. The component is passed a lead identifier and returns a rating score for that lead. In block 901, the component initializes the rating score. In blocks 902-906, the component loops factoring in scores from various rating organizations into the rating score. In block 902, the component selects the next rating organization. In decision block 903, if all the rating organizations have already been selected, then the component returns the rating score, else the component continues at block 904. In block 904, the component retrieves the weight for the rating organization. In block 905, the component retrieves the rating from the rating organization. The lead qualification system may have an electronic interface to each rating organization through which it submits the identification of the potential customer and receives a rating score in return. In block 906, the component aggregates the rating into the rating score, factoring in the weight. The component then loops to block 902 to select the next rating organization.

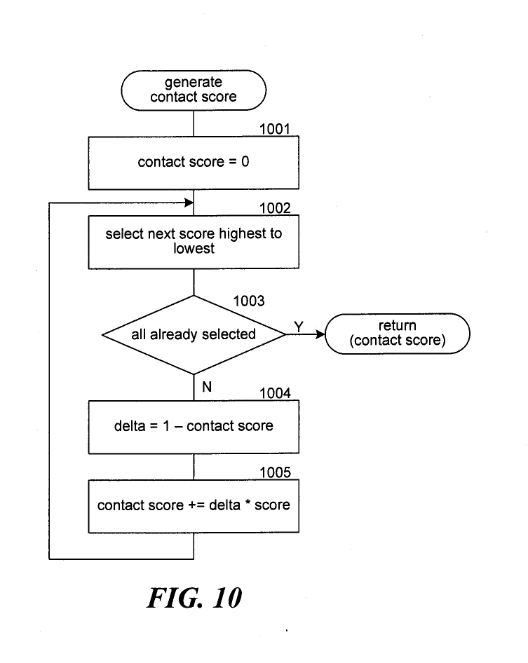

FIG. 10 is a flow diagram that illustrates the processing of the generate contact score component of the lead qualification system in some embodiments. The component is passed a lead identifier and returns a contact score for that lead. The component may aggregate the strength of all the direct and indirect relationships between employees of the sales organization and employees of the potential customer. The component may also adjust the strengths of the relationships based on their potential to help with a sale. For example, the relationship between a sales manager of the sales organization and a purchasing manager of a potential customer may be more valuable than the relationship between a staff attorney of the sales organization and a paralegal of the potential customer. The adjusted scores for the strengths of relationships may range between 0 and 1.0. In block 1001, the component initializes the contact score. In blocks 1002-1005, the component loops aggregating the adjusted scores into the contact score so that the contact score is between 0 and 1.0. In block 1002, the component selects the next adjusted score starting with the highest adjusted score. In decision block 1003, if all the adjusted scores have already been selected, then the component returns the contact score, else the component continues at block 1004. In block 1004, the component calculates a delta between one and the contact score. The use of the delta ensures that the aggregation of the adjusted scores will not exceed 1.0. In block 1005, the component adds the delta times the adjusted score to the contact score and then loops to block 1002 to select the next adjusted score.

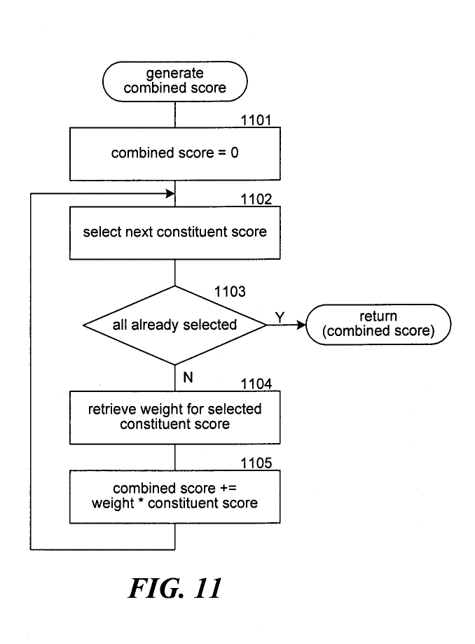

FIG. 11 is a flow diagram that illustrates the processing of the generate combined score component of the lead qualification system in some embodiments. The component is passed constituent scores and returns a combined score as the lead score. The component may generate a weighted combination of the combined scores. In block 1101, the component initializes the combined score. In blocks 1102-1105, the component loops aggregating each constituent score into the combined score. In block 1102, the component selects the next constituent score. In decision block 1103, if all the constituent scores have already been selected, then the component returns the combined score, else the component continues at block 1104. In block 1104, the component retrieves the weight for the selected constituent score. In block 1105, the component adds the weighted constituent score to the combined score and then loops to block 1102 to select the next constituent score.

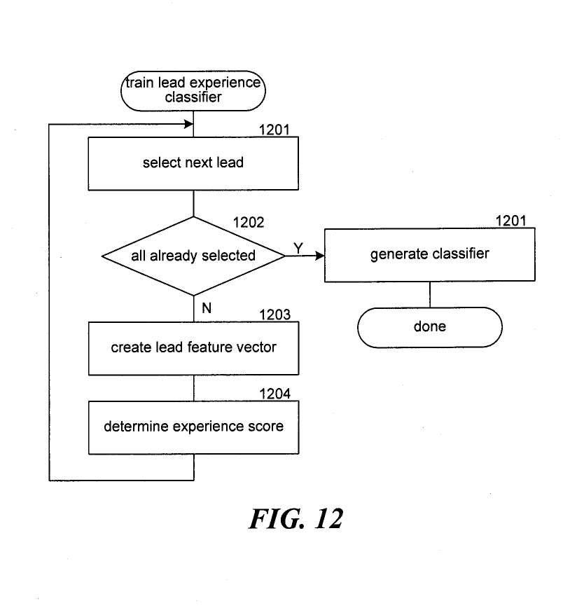

FIG. 12 is a flow diagram that illustrates the processing of the train lead experience classifier component of the lead qualification system in some embodiments. The component is provided with leads and determines an experience score for the leads. The leads and the experience scores represent the training data for training the lead experience classifier. In block 1201, the component selects the next lead. In decision block 1202, if all the leads have already been selected, then the component continues at block 1205, else the component continues at block 1203. In block 1203, the component generates a lead feature vector based on the attributes of the lead. In block 1204, the component determines an experience score for the lead. The experience score may be calculated automatically from lead and sales history information for that lead or may be manually input by a salesperson. The component then loops to block 1201 to select the next lead. In block 1205, the component generates the classifier using the training data and then completes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing device with a processor and memory for qualifying business leads for a sales organization, the method comprising:
providing a business network store describing business relationships between people associated with various organizations;
receiving from a potential customer lead information that includes an identification of the potential customer;
identifying attributes of the potential customer; and
generating a lead score for the potential customer based on analysis of customers with attributes similar to attributes of the potential customer and based on business relationships between people of the sales organization and the potential customer as indicated by the business network store.

2. The method of claim 1 wherein the generating of the lead score for the potential customer based on analysis of customers with attributes similar to attributes of the potential customer includes:
providing training data that includes, for each of a plurality of customers, customer attributes and an experience score, the experience score being a rating of value of the customer to the sales organization;
training a lead experience classifier to classify potential customers by generating a lead experience score based on customer attributes of the potential customers; and
applying the lead experience classifier to the customer attributes of the potential customer to generate a lead experience score for the potential customer.

3. The method of claim 2 wherein the experience scores are derived from analysis of lead and sales history information of the customers.

4. The method of claim 1 wherein the identifying of attributes includes extracting attributes from the lead information received from the potential customer.

5. The method of claim 1 wherein the generating of the lead score is further based on company rating information.

6. The method of claim 1 wherein the generating of the lead score is further based on analytics derived from secondary actions of a representative of the potential customer during a session in which the representative provided the lead information, an action being primary when it relates directly to entry of lead information and secondary when it does not relate directly to the entry of the lead information.

7. The method of claim 1 wherein the generating of the lead score includes generating an experience score and a contact score.

8. The method of claim 7 wherein the experience score and the contact score are combined based on user-specified weights to generate the lead score.

9. The method of claim 1 wherein the business network store specifies attributes of each person and a strength of the relationship between two people that is derived from attributes of the two people and their relationships to other people.

10. The method of claim 9 wherein the generating of the lead score based on business relationships between people of the sales organization and the potential customer as indicated by the business network store is based on the strength of the relationships between the people.

11. A computer-readable storage medium containing computer-executable instructions for controlling a computing device with a processor and memory to qualify business leads for a sales organization, by a method comprising:
receiving from a potential customer lead information that includes an identification of the potential customer;
identifying attributes of the potential customer; and
generating a lead score for the potential customer by:
generating an analytics score based on analytics derived from secondary actions of the potential customer during a session in which the potential customer provided the lead information, an action being primary when it relates directly to entry of lead information and secondary when it does not relate directly to the entry of the lead information;
generating an experience score based on analysis of customer information of customers with attributes similar to attributes of the potential customer, the customer information including sales history information of the customers;
generating a contact score based on business relationships between people of the sales organization and the potential customer as indicated by the business network store describing business relationships between people associated with various organizations; and
calculating the lead score as a weighted combination of the analytics score, the experience score, and the contact score.

12. The computer-readable storage medium of claim 11 wherein the generating of the experience score includes applying a clustering algorithm to identify customers with similar attributes.

13. The computer-readable storage medium of claim 11 wherein the generating of the lead score includes generating a rating score derived from one or more ratings of the potential customer by an organization other than the sales organization.

14. The computer-readable storage medium of claim 11 wherein the business network store specifies attributes of each person and a strength of the relationship between two people that is derived from attributes of the two people and their relationships to other people.

15. A computer system for qualifying business leads for a sales organization, comprising:
a memory storing a business network store describing business relationships between people associated with various organizations and storing computer-executable instructions that:
receive from a potential customer lead information that includes an identification of the potential customer;
identify attributes of the potential customer; and
generate a lead score for the potential customer based on
an experience score derived from analysis of customer information of customers with attributes similar to attributes of the potential customer, the customer information including sales history information of the customers, and
a contact score based on business relationships between people of the sales organization and the potential customer as indicated by a business network store describing business relationships between people associated with various organizations; and
a processor for executing the computer-executable instructions stored in the memory.

16. The computer system of claim 15 wherein the lead score is further generated based on an analytics score derived from secondary actions of the potential customer during a session in which the potential customer provided the lead information, an action being primary when it relates directly to entry of lead information and secondary when it does not relate directly to the entry of the lead information.

17. The computer system of claim 16 wherein the lead score is calculated as a weighted combination of the analytics score, the experience score, and the contact score.

18. The computer system of claim 15 wherein the experience score is generated by identifying customers with similar attributes based on a distance in a multi-dimensional vector space with each dimension representing an attribute of a customer.

19. The computer system of claim 15 wherein the lead score is further generated based on a rating score derived from one or more ratings of the potential customer by an organization other than the sales organization.

20. The computer system of claim 15 wherein the lead score is calculated as a user-specified weighted combination of the experience score and the contact score.
